(19) United States
(12) Patent Application Publication
(10) Pub. No.: US 2004/0080496 A1
(43) Pub. Date: Apr. 29, 2004

(54) Optical cursor control device

(76) Inventors: Jang Sik Cheon, Yongin-city (KR); Duck Young Jung, Yongin-city (KR)

Correspondence Address: CANTOR COLBURN LLP, 55 Griffin Road South, Bloomfield, CT, 06002, US

(21) Appl. No.: 10/691,272

(22) Filed: Oct. 21, 2003

(30) Foreign Application Priority Data
Oct. 23, 2002 (KR) 2002-64989

(51) Int. Cl. G09G 5/08

(52) U.S. Cl. 345/166

(57) ABSTRACT

An optical cursor control device is provided. The optical cursor control device includes a worktable, and an optical mouse moved on the worktable by an operator. The optical mouse has a case. A light guide is disposed at a sidewall of the case to introduce external light of the case into the case. An optical sensor is disposed in the case to detect the light outputted from the light guide. An output signal of the optical sensor is processed by electronic parts on a printed circuit board, and the electronic parts generate an output signal that corresponds to a position of the case.

### CROSS-REFERENCE TO RELATED APPLICATION

This application claims the benefit of Korean Patent Application No. 2002-64989, filed Oct. 23, 2002, the disclosure of which is hereby incorporated herein by reference in its entirety.

### BACKGROUND OF THE INVENTION

1. Field of the Invention

The present invention relates to cursor control devices and, more particularly, to optical cursor control devices.

2. Description of the Related Art

A mouse is extensively adopted in a computer in order to control a position of a cursor viewed on a display device. This mouse may be classified into a ball mouse and an optical mouse. The ball mouse is placed on a surface of a medium and has a ball which contacts with the surface of the medium. Thus, if the ball mouse is used for a long period of time, a dust or the like is adhered to a surface of the ball and causes malfunction of the ball mouse. In order to solve this problem with the ball mouse, the optical mouse is widely used instead of the ball mouse.

The optical mouse generally comprises a light emitting device for emitting light onto the surface of the medium and an optical sensor for sensing vertically reflected lights of the lights reflected from the surface of the medium. As the light emitting device, a device generating infrared rays or visual spectral rays is extensively used. The medium may be classified into two categories. One is a pad on which specific patterns are drawn, and the other is a typical worktable with irregular surface morphology. If the pad is adopted, there exists a constraint that the optical mouse should be used only on the pad. On the other hand, if the typical worktable is used instead of the pad, the light emitted from the light emitting device should have a great intensity of illumination higher than 1,600 lux. This is for maximizing the intensity of the vertically reflected lights, which are reflected from the surface of the worktable, to increase a margin of sensitivity of the optical sensor.

Meanwhile, in the event that the infrared rays or visual spectral rays are directly irradiated toward human eyes, the human eyes are considerably damaged. Therefore, when the optical mouse having the light emitting device for emitting the infrared rays or visual spectral rays is used, an operator is required to pay careful attention.

The optical mouse is taught in U.S. Pat. No. 5,686,720 to Tullis, entitled “Method and Device for Achieving High Contrast Surface Illumination”. The optical mouse disclosed in the U.S. Pat. No. 5,686,720 is characterized in that an incident ray having an incident angle smaller than 160 is irradiated onto a surface of a medium having an irregular surface morphology. The incident angle means an angle between the incident ray and the surface of the medium.

According to the conventional art as described above, the infrared rays or visual spectral rays are used to sense the location of the optical mouse. Accordingly, eyes of an operator who manipulates the mouse may be damaged. Moreover, since the light emitted from the light emitting device is required to have an intensity of illumination higher than a specific value, power consumption of the optical mouse is remarkably higher than that of the ball mouse.

### SUMMARY OF THE INVENTION

It is an object of the present invention to provide an optical cursor control device for sensing a position of an optical mouse by using light that is not harmful to a human body.

It is another object of the present invention to provide an optical cursor control device with low power consumption.

In order to achieve the objects, the present invention provides an optical cursor control device comprising a worktable and an optical mouse moved on the worktable by an operator.

According to an aspect of the present invention, the optical mouse includes a case; a light guide disposed at a sidewall of the case for guiding external light of the case into the case; an optical sensor disposed in the case for sensing the light outputted from the light guide; and a printed circuit board for processing a signal outputted from the optical sensor to generate an output signal corresponding to a position of the case.

The light guide may be a prism or a light amplifying mean. In the event that the light guide is the prism, the prism has a first area for transmitting light reflected from a surface of the worktable adjacent to the case, and a second area for illuminating the light, which is introduced through the first area, to the optical sensor. On the other hand, in the event that the light guide is the light amplifying mean, it is desirable that the optical mouse includes a lower panel with an opening. Accordingly, the light passing through the light amplifying mean is illuminated onto the surface of the worktable through the opening, and the light illuminated onto the surface of the worktable is reflected and illuminated to the optical sensor. In this case, the optical mouse may further include a light emitting device installed in the case. The light emitting device can be manually or automatically operated. In a preferred embodiment of the present invention, the light emitting device is turned on when the external light has a weak intensity. Lights from the light emitting device are irradiated onto the surface of the worktable through the opening.

In order to achieve the objects, the present invention comprises an optical cursor control device having a light concentrating pad and an optical mouse moved on the light concentrating pad by an operator.

According to an aspect of the present invention, the light concentrating pad includes a light concentrating plate; an optical wave guide for passing light reflected from the light concentrating plate; a lower reflecting plate attached to a bottom of the optical wave guide for upwardly reflecting the light introduced through the optical wave guide; and an upper transparent plate attached to a top of the optical wave guide for passing the light reflected from the lower reflecting plate.

According to another aspect of the present invention, the light concentrating pad includes a light source; an optical wave guide for passing light emitted from the light source; a lower reflecting plate attached to the bottom of the optical wave guide for upwardly reflecting the light introduced into the optical wave guide; and an upper transparent plate attached to the top of the optical wave guide for passing the light reflected from the lower reflecting plate.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a schematic cross-sectional view of an optical cursor control device according to a first embodiment of the present invention;

FIG. 2 is a schematic cross-sectional view of an optical cursor control device according to a second embodiment of the present invention;

FIG. 3a is a schematic perspective view of an optical cursor control device according to a third embodiment of the present invention;

FIG. 3b is a schematic cross-sectional view of the optical cursor control device shown in FIG. 3a; and

FIG. 4 is a cross-sectional view showing a pad of an optical cursor 0.20 control device according to a fourth embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

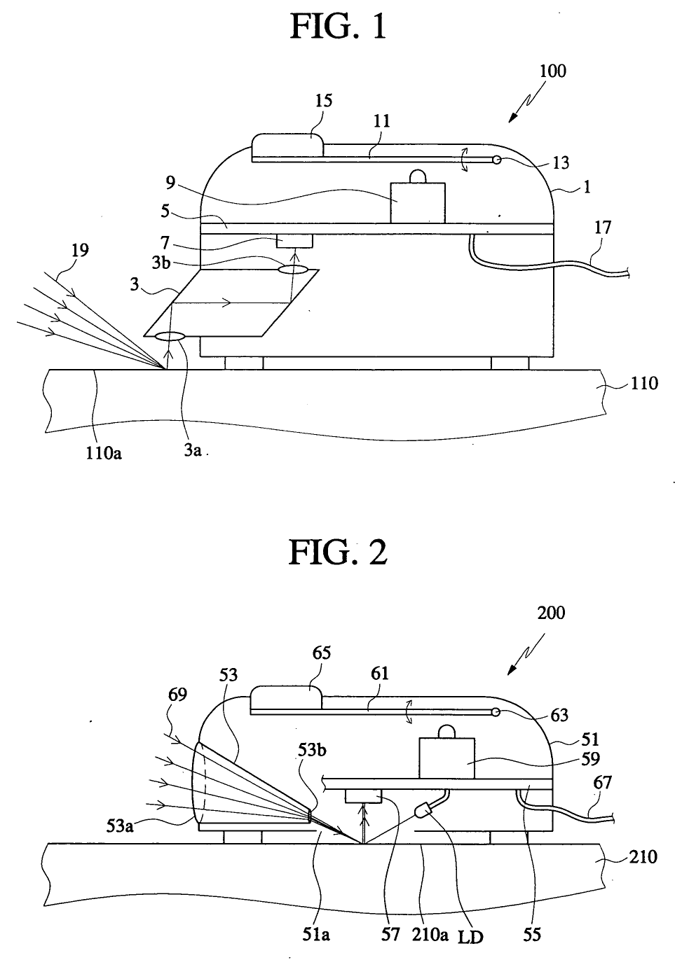

FIG. 1 is a schematic cross-sectional view showing an optical cursor control device according to a first embodiment of the present invention.

Referring to FIG. 1, the optical cursor control device includes a worktable 110, and an optical mouse 100 horizontally moved on the worktable 110 by an operator. The worktable 110 has an upper surface 110a with irregular surface morphology.

Referring back to FIG. 1, the optical mouse 100 includes a case 1 for providing a closed space, and a light guide 3, e.g., prism mounted on a sidewall of the case 1. A side of the prism 3 is outwardly protruded from the case 1 to receive light reflected from the upper surface of the worktable 110 adjacent to the case 1. Specifically, external light 19 of the case 1 is reflected by the upper surface 110a adjacent to the case 1 to thereby pass through a lower surface of a protruded portion of the prism 3, i.e., a first area. The light introduced into the prism 3 through the first area is illuminated into the case 1 through a second area of the prism 3. The light passing through the prism 3 is illuminated to an optical sensor 7, which is mounted inside the case 1.

Preferably, first and second light concentrating means 3a and 3b are disposed in the first and second areas, respectively. The first and second light concentrating means 3a and 3b may be convex lenses. In this case, since an intensity of the light passing through the prism 3 increases, a sensing margin of the optical sensor 7 can be improved. The optical sensor 7 is mounted on a printed circuit board 5, which is disposed inside the case 1. Thus, an output signal of the optical sensor 7 is converted to an electric signal, which corresponds to a current position of the case 1, by a predetermined circuit mounted on the printed circuit board 5, and the converted signal is transferred to a main board of a computer via wiring 17 connected to the printed circuit board 5.

Moreover, a switch module 9 is mounted on a predetermined area of the printed circuit board 5. A horizontal support 11 is disposed above the switch module 9. A hinge 13, which is fixed inside the case 1, is connected to one side of the support 11, while a button 15, which penetrates the top of the case 1, is positioned on the other side of the support 11. The support 11 has a restoring force, provided by a resilient member (not shown) such as a spring, being separated away from the switch module 9. Accordingly, whenever pressing the button 15 down, the switch module 9 is turned on. As a result, if the button 15 is clicked on, an electrical signal notifying that the button 15 is pressed down is transferred to the computer together with information related to a current position of the optical mouse 100.

According to the first embodiment of the present invention as described above, the optical mouse 100 generates a signal corresponding to the current position of the optical mouse 100 by using external light such as natural light or a typical electric illumination. Accordingly, there is no need for a light emitting device as adopted in the conventional optical mouse. As a result, power consumption of the optical mouse 100 can be minimized.

FIG. 2 is a schematic cross-sectional view showing an optical cursor control device according to a second embodiment of the present invention.

Referring to FIG. 2, an optical mouse 200 is movably placed on a worktable 210. The worktable 210 is the same as the worktable 110 of the first embodiment. Thus, the worktable 210 has an upper surface 210a with irregular surface morphology as well. The optical mouse 200 includes a case 51, and a light guide 53 disposed at a sidewall of the case 51. The case 51 has a lower panel with an opening 51a, unlike the case 1 of the first embodiment. In addition, the light guide 53 has different form and function from those of the light guide 3 in the first embodiment. In this embodiment, the light guide 53 has a light concentrating surface 53a for receiving external light 69 of the case 51, and an illuminating surface 53b for illuminating the light passing through the light concentrating surface 53a onto the upper surface 210a of the worktable 210. The light passing through the illuminating surface 53b is illuminated onto the worktable 210 through the opening 51a. Here, the illuminating surface 53b has an area smaller than that of the light concentrating surface 53a. Accordingly, the light guide 53 increases an intensity of the external light 69. That is, the light guide 53 acts as a light amplifying mean.

The light introduced through the light guide 53 and the opening 51a is reflected on the upper surface 210a of the worktable 210 and is illuminated to an optical sensor 57 mounted inside the case 51. The optical sensor 57 is mounted on a printed circuit board 55 disposed inside the case 51, as in the first embodiment. Moreover, the optical mouse 200 further includes a switch module 59 mounted on the printed circuit board 55, a support 61 positioned above the switch module 59, a hinge 63 connected to one side of the support 61, a button 65 attached to the other side of the support 61, and wiring 67 connected to the printed circuit board 55.

Further, the optical mouse 200 may further include a light emitting device LD, which is installed in the case 51. The light emitting device LD can be manually or automatically turned on when the external light 69 has a weak intensity. In this case, the lights from the light emitting device LD are irradiated onto the surface 210a of the worktable 210 through the opening 51a. Accordingly, even though the intensity of the external light 69 is very weak, it is possible to improve a sensing margin of the optical sensor 57 by turning on the light emitting device LD.

According to the second embodiment of the present invention as described above, by increasing an area ratio of the light concentrating surface 53a to the illuminating surface 53b, the intensity of the light illuminated to the optical sensor 57 can be higher as compared to the first embodiment. Accordingly, a sense margin of the optical sensor 57 can be improved, resulting in an implementation of a high performance optical mouse.

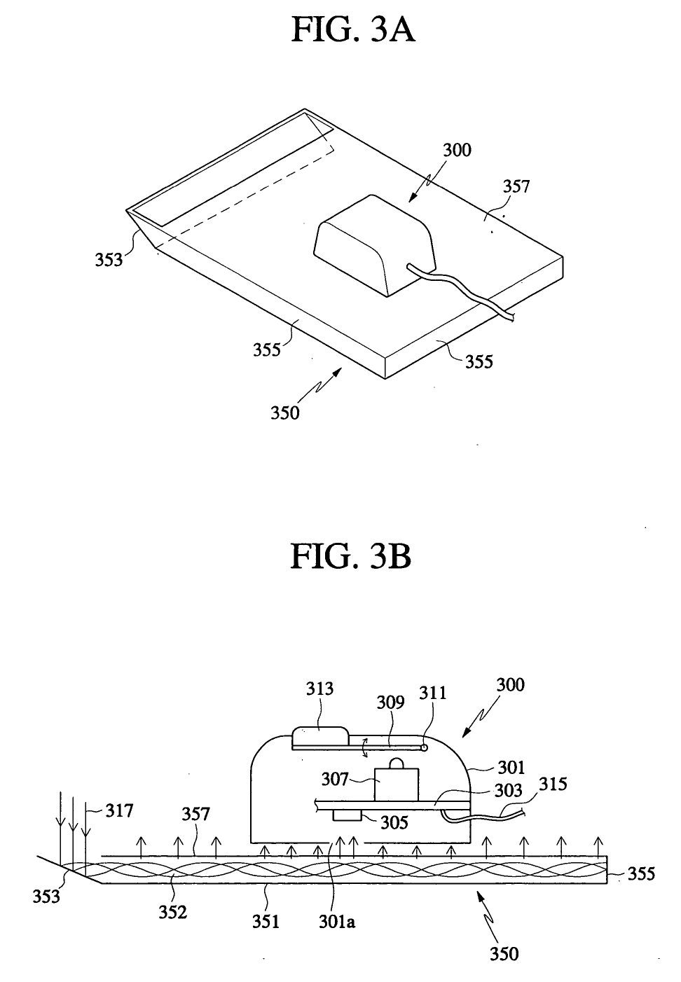

FIG. 3a is a schematic perspective view showing an optical cursor control device according to a third embodiment of the present invention, and FIG. 3b is a cross-sectional view of the optical cursor control device as shown in FIG. 3a.

Referring to FIGS. 3a and 3b, the optical cursor control device according to this embodiment includes a light concentrating pad 350 and an optical mouse 306 moved on the light concentrating pad 350. The optical mouse 300 has a lower panel with an opening 301a, as in the optical mouse 200 shown in the second embodiment. However, the optical mouse 300 does not adopt such light guides 5 and 53 as shown in the first and second embodiments. That is, the optical mouse 300 includes a case 301, a printed circuit board 303 disposed in the case 301, and an optical sensor 305 mounted on the printed circuit board 303, as shown in FIG. 3b. The optical sensor 305 is positioned above the opening 301a to sense light emitted from the light concentrating pad 350, as in the second embodiment. The printed circuit board 303 and the optical sensor 305 have the same functions as those in the first and second embodiments.

Furthermore, the optical mouse 300 includes a switch module 307 mounted on the printed circuit board 303, a support 309 disposed above the switch module 307, a hinge 311 connected to one side of the support 309, a button 313 attached to the other side of the support 309, and wiring 315 connected to the printed circuit board 303, as in the first and second embodiments. Each of the switch module 307, support 309, rotational axis 311, button 313 and wiring 315 has the same function as that in the first and second embodiments.

Meanwhile, the light concentrating pad 350 includes a light concentrating plate 353 for reflecting light 317 such as natural light or an electrical illumination, an optical wave guide 352 for passing the light reflected from the light concentrating plate 353, and a lower reflecting plate 351 attached to a bottom of the optical wave guide 352. The lower reflecting plate 351 upwardly reflects the light transferred through the optical wave guide 352. In addition, an upper transparent plate 357 is attached to a top of the optical wave guide 352, and side reflecting plates 355 are attached to sides of the optical wave guide 352. Further, the upper transparent plate 357 is attached to the top of the optical wave guide 352. Thus, the light reflected by the light concentrating plate 353 is transferred through the optical wave guide 352, and the light introduced into the optical wave guide 352 is reflected by the lower reflecting plate 351 and the side reflecting plates 355 so that it is emitted upwardly through the upper transparent plate 357. The light transmitted through the upper transparent plate 357 is illuminated to the optical sensor 305 through the lower opening 301a of the optical mouse 300.

It is desirable that the upper transparent plate 357 of the light concentrating pad 350 has regular patterns arranged in two-dimension. Thus, the optical sensor 305 recognizes the regular patterns arranged at respective positions of the light concentrating pad 350 to transfer them to the printed circuit board 303. The printed circuit board 303 processes the patterns recognized by the optical sensor 305 to output an electric signal corresponding to a current position of the optical mouse 300.

The light concentrating plate 353 may be an inclined flat panel, as shown in FIGS. 3a and 3b. However, the light concentrating plate 353 may have a concave surface in order to increase an intensity of the light that is incident into the optical wave guide 352.

The optical cursor control device according to the third embodiment as described above adopts the light concentrating pad for upwardly emitting the natural light or the electrical illumination to recognize the position of the optical mouse, in place of the light emitting device for emitting infrared rays or visual spectral rays that are harmful to the human body. Accordingly, it is possible to minimize power consumption of the optical mouse. Moreover, it is not required to adjust an incident angle of the light emitted from the light emitting device to be smaller than 160 as in the conventional art.

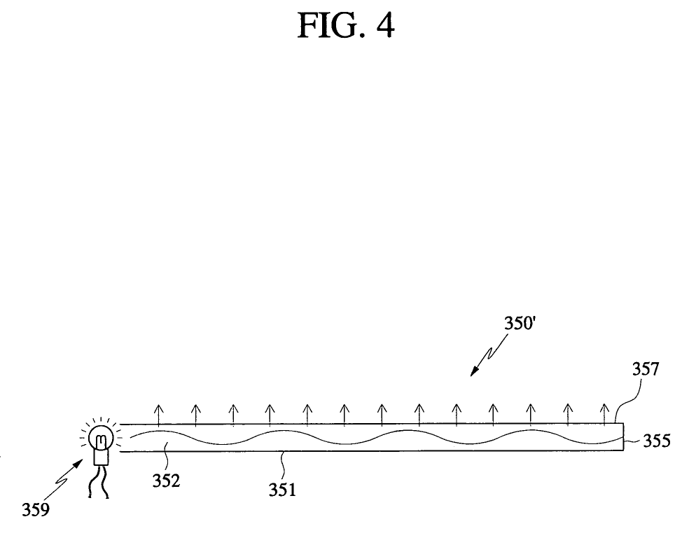

FIG. 4 is a cross-sectional view for explaining a light concentrating pad of an optical cursor control device according to a fourth embodiment of the present invention. The optical cursor control device according to this embodiment includes a light concentrating pad and an optical mouse, as in the third embodiment. The optical mouse of this embodiment has the same structure as that of the optical mouse discussed in the third embodiment. Therefore, an explanation on the optical mouse will be omitted.

Referring to FIG. 4, a light concentrating pad 350′ of the optical cursor control device according to this embodiment has a similar structure to that of the light concentrating pad 350 of the third embodiment. However, the light concentrating pad 350′ adopts a light source 359 in place of the light concentrating plate 353 of the third embodiment. The light source 359 may be a typical lamp other than a light emitting device for generating infrared rays or visual spectral rays. Accordingly, even in case that there is no an illumination system or natural light around the optical cursor control device, it is possible to sense the position of the optical mouse.

According to the present invention as described above, natural light or an electrical illumination is used in place of an infrared rays or visual spectral rays emitting device as used in the conventional art. Accordingly, it is possible to implement a low power optical cursor control device that is not harmful to operator's eyes. In addition, it is not required in the present invention to adjust an incident angle of the light illuminated onto a pad or a worktable to be smaller than 16°. Consequently, even though the optical mouse is separated away from the pad or the worktable, a malfunction of the optical mouse can be prevented.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical cursor control device having a worktable and an optical mouse moved on the worktable by an operator, the optical mouse comprising:
a case;
a light guide disposed at a sidewall of the case to introduce external lights into the case;
an optical sensor disposed in the case to detect output lights of the light guide; and
a printed circuit board with electronic parts processing an output signal of the optical sensor to generate an output signal that corresponds to a position of the case.

2. The optical cursor control device according to claim 1, wherein the light guide is a prism.

3. The optical cursor control device according to claim 2, wherein the prism has a first area that accepts lights reflecting from a surface of the worktable adjacent to the case and a second area that introduces lights passing through the first area into the optical sensor.

4. The optical cursor control device according to claim 3, wherein the prism further comprising light concentrators disposed at the first and second areas, and the light concentrators increase light intensities passing through the light concentrators.

5. The optical cursor control device according to claim 4, wherein the light concentrators are convex lenses.

6. The optical cursor control device according to claim 1, further comprising:
a switch module mounted on the printed circuit board; and
a button disposed on a top of the case to turn on or off the switch module.

7. The optical cursor control device according to claim 1, wherein the light guide have a light concentrating surface that accept external lights of the case and an illuminating surface irradiating lights penetrating the light concentrating surface onto the surface of the worktable through an opening formed in a lower panel of the case, the illuminating surface having an area smaller than that of the light concentrating surface and the optical sensor detecting lights reflected from the surface of the worktable.

8. The optical cursor control device according to claim 7 further comprises a light emitting device installed in the case, wherein the light emitting device is automatically or manually turned on and lights from the light emitting device are irradiated onto the surface of the worktable through the opening.

9. An optical cursor control device having a light concentrating pad and an optical mouse moved on the light concentrating pad by an operator, the light concentrating pad comprising:
a light concentrating plate;
an optical wave guide for passing light reflected from the light concentrating plate;
a lower reflecting plate attached to a bottom of the optical wave guide for upwardly reflecting the light introduced into the optical wave guide; and
an upper transparent plate attached to a top of the optical wave guide for passing the light reflected from the lower reflecting plate.

10. The optical cursor control device according to claim 9, wherein the upper transparent plate includes regular patterns drawn on a surface thereof.

11. The optical cursor control device according to claim 9, wherein the optical mouse comprising:
a case including a lower panel, the lower panel having an opening;
an optical sensor mounted inside the case for sensing reflected light introduced into the case through the opening; and
a printed circuit board for processing a signal outputted from the optical sensor to generate an output signal that corresponds to a position of the case.

12. The optical cursor control device according to claim 11, wherein the optical mouse further comprising:
a switch module disposed on the printed circuit board; and
a button disposed at the top surface of the case to turn on or off the switch module.

13. An optical cursor control device having a light concentrating pad, and an optical mouse moved on the light concentrating pad by an operator, the light concentrating pad comprising:
a light source;
an optical wave guide for passing light emitted from the light source;
a lower reflecting plate attached to a bottom of the optical wave guide for upwardly reflecting the light introduced into the optical wave guide; and
an upper transparent plate attached to a top of the optical wave guide for passing the light reflected from the lower reflecting plate.

14. The optical cursor control device according to claim 13, wherein the upper transparent plate includes regular patterns drawn on a surface thereof.

15. The optical cursor control device according to claim 13, wherein the optical mouse comprising:
a case including a lower panel with an opening;
an optical sensor mounted inside the case for sensing reflected light introduced through the opening; and
a printed circuit board with electronic parts processing a signal outputted from the optical sensor to generate an output signal that corresponds to a position of the case.

16. The optical cursor control device according to claim 15, wherein the optical mouse further comprising:
a switch module disposed on the printed circuit board; and
a button disposed at the top surface of the case to turn on or off the switch module.
